(19) United States
(12) Patent Application Publication
(10) Pub. No.: US 2010/0271337 A1
(43) Pub. Date: Oct. 28, 2010

(54) Touch panel and touch display apparatus having the same

(75) Inventors: Jae Heon Noh, Hwaseong-si (KR); Jong II Kim, Anyang-si (KR); Dong Seob Jang, Seoul (KR); Jae Young Kim, Anyang-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/659,645

(22) Filed: Mar. 16, 2010

(30) Foreign Application Priority Data
Apr. 22, 2009 (KR) 10-2009-0034888

(51) Int. Cl. G06F 3/042

(52) U.S. Cl. 345/176

(57) ABSTRACT

Disclosed herein are a touch panel and a touch display apparatus having the same. As disclosed, a touch panel may include a window unit, reflection units, and detection units. As disclosed, the reflection units may be on the window unit and may be configured to reflect scattered light when the window unit is touched. As disclosed, the detection units may be on the window unit and the detection units may be configured to detect the reflected scattered light.

### CROSS-REFERENCE TO RELATED APPLICATION

This application claims priority under 35 U.S.C. §119 to Korean Patent Application No. 2009-0034888, filed on Apr. 22, 2009 in the Korean Intellectual Property Office (KIPO), the entire contents of which are herein incorporated by reference.

### BACKGROUND

1. Field

Example embodiments relate to a touch panel which may have a reduced thickness, and a touch display apparatus having the same.

2. Description of the Related Art

A conventional touch panel is a panel device which detects a position of a letter or an icon when the letter or the icon is selected by a touch of an object. Additionally, the conventional touch panel processes a function corresponding to the selected letter or icon when the letter or the icon is selected by a touch of an object. A conventional touch display apparatus includes a touch panel and a display panel. The conventional touch display apparatus provides the touch panel and the display panel together. The conventional touch display apparatus displays image data on a screen to provide the image data to a user and detects a position of a letter or an icon displayed on the screen. When a letter or an icon is selected by a touch of an object, for example, a human finger or a pen, the conventional touch display apparatus processes a function corresponding to the selected letter or icon. Conventional touch display apparatuses have been used in various instruments, for example, as an individual portable terminal, an automated teller machine, a notebook computer, a monitor, a television, and a digital information display (DID).

The touch panels are divided into a resistive type, a capacitive type, an ultrasonic type, and an optical type, using, for example, infrared rays. The resistive and capacitive type touch panels detect a position selected by a user thereon from a resistance and a capacitance obtained when the user generates a contact point, and the ultrasonic and optical type touch panels form a kind of grating row due to ultrasonic waves or light and then detect a position selected by a user on the touch panels based on whether or not light is detected.

The resistive type touch panel has a difficulty in achieving a multi-touch function. Furthermore, the resistive type touch panel uses a direct heat application method, and thus causes scratches on the surface thereof, thereby causing problems in durability and parts thereof. Additionally, the resistive type touch panel has a low transmissivity of a film used as a conductive film, and thus lowers an image quality and causes a difficulty in increasing a size of the panel to 10 inches or more.

The capacitive type touch panel is not operated using a nonconductive input unit, for example, a touch pen, and has a low recognition rate and low accuracy according to humidity and environment. The capacitive type touch panel requires parts having a high manufacturing cost to achieve a multi-touch function.

The ultrasonic type touch panel has a relatively high durability but has a relatively thick thickness, a relatively low resolution, and a relatively high cost.

The optical type touch panel has a relatively high durability and thus does not have a difficulty in maintenance and repair and has a simple structure and thus has an increased size, but has a thick thickness of a bezel around the touch panel.

### SUMMARY

Example embodiments provide a touch panel, which may have a reduced thickness, and a touch display apparatus having the same.

Example embodiments will be set forth in part in the description which follows and, in part, will be obvious from the description, or may be learned by practice of the disclosure.

In accordance with example embodiments, a touch panel may include a window unit, reflection units, and detection units. In example embodiments, the reflection units may be on the window unit and the reflection units may be configured to reflect scattered light from the window unit when the window unit is touched. In example embodiments, the detection units may be on the window unit and the detection units may be configured to detect the reflected scattered light.

In accordance with example embodiments, a touch display apparatus may include a touch panel and a display panel. In example embodiments, the touch panel may include a window unit, reflection units and detection units. The reflection units may be on the window unit and the reflection units may be configured to reflect scattered light from the window unit when the window unit is touched. The detection units may be on the window unit and may be configured to detect the reflected scattered light. In example embodiments, the display panel to may be configured to display an image corresponding to a position where the scattered light is detected.

In accordance with example embodiments, a touch panel may include a window unit, reflection units installed on the window unit to reflect light scattered when the window unit is touched, and detection units installed on the window unit to respectively detect images of the reflected light.

The reflection units and the detection units may be installed at the lower portion of the window unit.

The touch panel may further include at least one light source unit to output light to the window unit.

The at least one light source unit may be installed at one corner of the window unit to output light.

The number of the at least one light source unit may be plural such that the at least one light source unit may be installed at regular intervals on one surface of the window unit.

The reflection units may form a tilt angle with the window unit.

The touch panel may further include a control unit to calculate coordinates of the touch position based on the positions of the images detected by the detection units.

The detection units and the reflection units may be opposite to each other.

The reflection units may include a first reflection unit and a second reflection unit to represent two-dimensional coordinates, and the detection units may include a first detection unit to detect the image of the light reflected by the first reflection unit, and a second detection unit to detect the image of the light reflected by the second reflection unit.

Each of the detection units may include a complementary metal oxide semiconductor field effect transistor (CMOS) or a charge-coupled device (CCD).

In accordance with example embodiments, a touch display apparatus may include a touch panel including a window unit, reflection units installed on the window unit to reflect light scattered when the window unit is touched, and detection units installed on the window unit to respectively detect images of the reflected light, and a display panel to display an image corresponding to a position where the images of the scattered light are detected.

The reflection units and the detection units may be installed at the lower portion of the window unit.

The touch display apparatus may further include at least one light source unit to output light to the window unit.

The reflection units may form a tilt angle with the window unit.

The touch display apparatus may further include a control unit to calculate coordinates of the touch position based on the positions of the images detected by the detection units.

The detection units and the reflection units may be opposite to each other.

The reflection units may include a first reflection unit and a second reflection unit to represent two-dimensional coordinates, and the detection units may include a first detection unit to detect the image of the light reflected by the first reflection unit, and a second detection unit to detect the image of the light reflected by the second reflection unit.

### BRIEF DESCRIPTION OF THE DRAWINGS

Example embodiments will be more clearly understood from the following detailed description taken in conjunction with the accompanying drawings. FIGS. 1-5C represent non-limiting, example embodiments as described herein. In the drawings:

FIG. 1A is an exploded perspective view of a touch display apparatus in accordance with example embodiments;

FIG. 1B is an exploded perspective view of a touch display apparatus having multiple light source units in accordance with example embodiments;

FIG. 2 is a longitudinal-sectional view of the touch display apparatus in accordance with example embodiments;

FIG. 3 is an exemplary view of a touch position detecting region of the touch display apparatus in accordance with example embodiments;

FIG. 4 is a control block diagram of the touch display apparatus in accordance with example embodiments; and

FIGS. 5A to 5C are views illustrating a process of detecting a touch position in the touch display apparatus in accordance with example embodiments.

### DETAILED DESCRIPTION

Example embodiments will now be described more fully with reference to the accompanying drawings, in which example embodiments are shown. The invention may, however, be embodied in different forms and should not be construed as limited to example embodiments set forth herein. Rather, example embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on”, “connected to”, or “coupled to” another element or layer, it can be directly on, connected to, or coupled to the other element or layer or intervening elements or layers that may be present. In contrast, when an element is referred to as being “directly on”, “directly connected to”, or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer, or section discussed below could be termed a second element, component, region, layer, or section without departing from the teachings of example embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Example embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configuration formed on the basis of manufacturing processes. Therefore, regions exemplified in figures have schematic properties and shapes of regions shown in figures exemplify specific shapes or regions of elements, and do not limit example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Reference will now be made in detail to the embodiments of the disclosure, examples of which are illustrated in the accompanying drawings, wherein like reference numerals refer to like elements throughout.

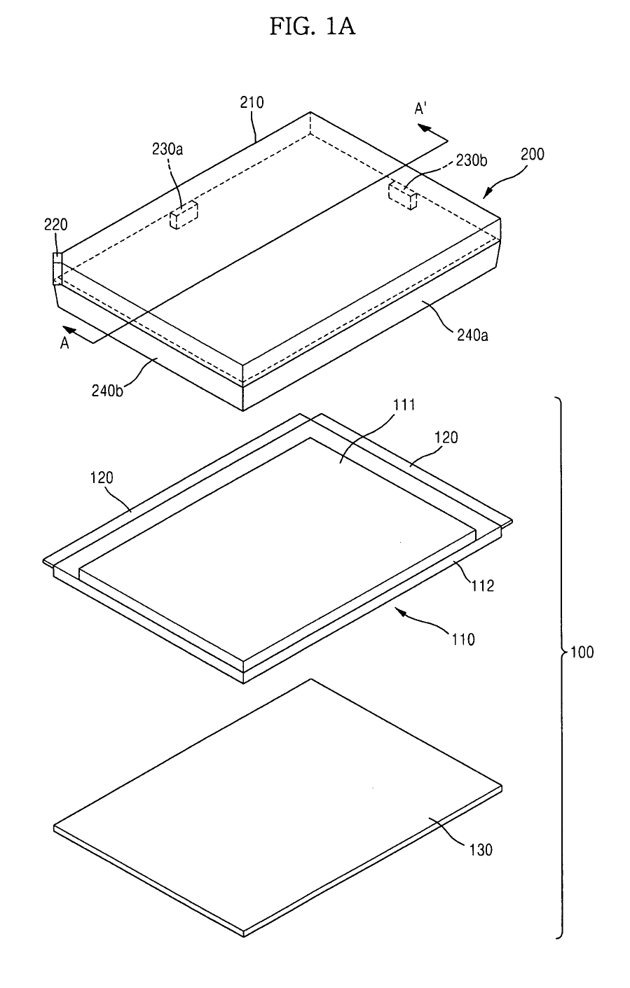

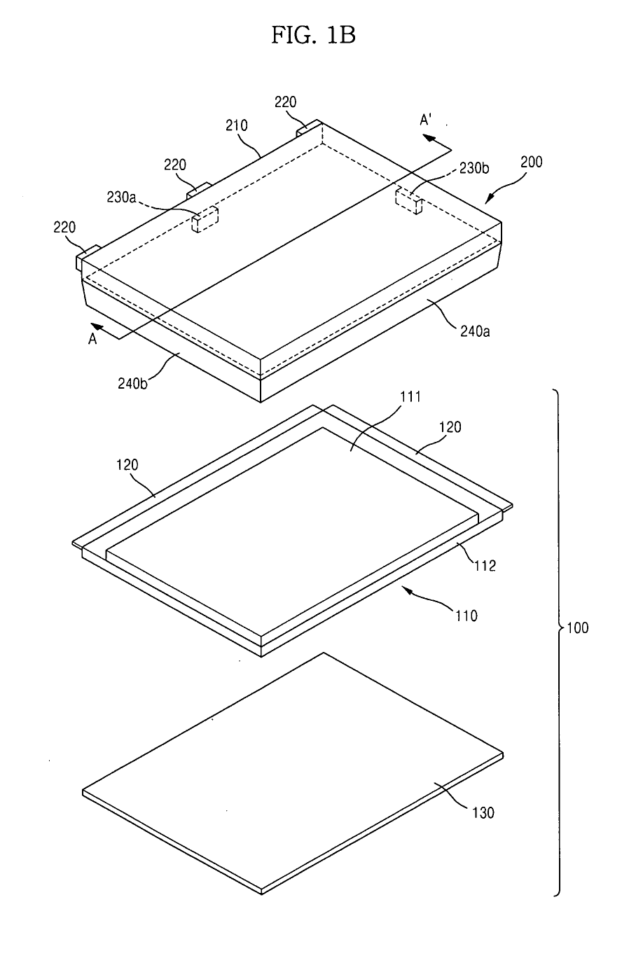

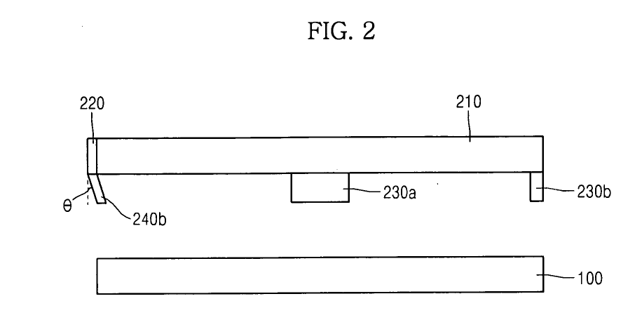

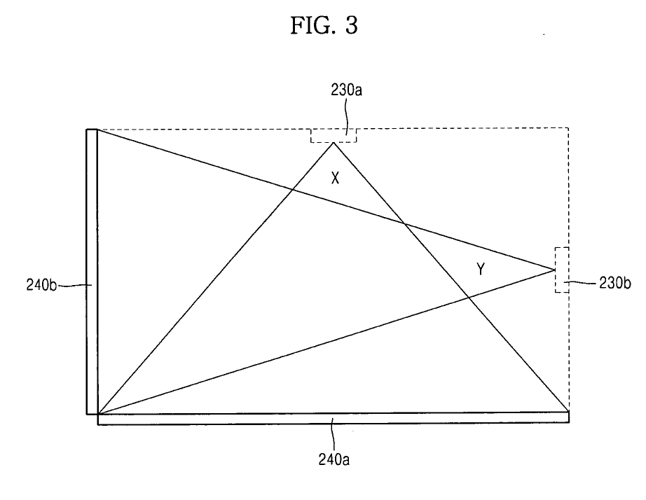

FIG. 1A is an exploded perspective view of a touch display apparatus in accordance with example embodiments, FIG. 2 is a longitudinal-sectional view taken along the line A-A′ of the touch display apparatus in accordance with example embodiments, and FIG. 3 illustrates an exemplary coordinate system of a touch position detecting region of the touch display apparatus in accordance with example embodiments. The touch display apparatus according to example embodiments includes a display panel 100 and a touch panel 200.

The display panel 100 may display an image. For example, the display panel 100 may display an image including letters and emoticons. Various displays, for example, a liquid crystal display (LCD), a light emitting diode display, and a plasma display, may be used as the display panel 100. Hereinafter, the display panel 100, to which a liquid crystal display (LCD) is applied, will be described.

However, example embodiments including a liquid crystal display (LCD) are not intended to limit the touch display apparatus.

As shown in FIG. 1A, the display panel 100 may include a liquid crystal unit 110 to form an image, a driving substrate 120 to drive the liquid crystal unit 110, and a backlight unit 130 to irradiate light onto the liquid crystal unit 110.

In example embodiments, the liquid crystal unit 110 may include a thin film transistor substrate 111, a color filter substrate 112 being opposite to the thin film transistor substrate 111, and liquid crystals (not shown) injected into a space between the thin film transistor substrate 111 and the color filter substrate 112. In example embodiments, the liquid crystal unit 110 may adjust light transmissivity of liquid crystal cells according to image data transmitted from the driving substrate 120, thus forming an image.

In example embodiments, the display panel 100 may display images, for example, images of letters or icons. When an object, for example, a user finger or a pen, touches a position corresponding to at least one the images displayed on the display panel 100, for example, the images of letters or icons, the touch panel 200 may detect the touch position and may transmit the detected result to a control unit 300 to obtain a function or an item selected by a user according to the touch position corresponding to the at least one image displayed on the display panel 100. In example embodiments, the control unit 300 may process instructions corresponding to the selected function or item, thereby allowing the user to obtain desired data.

The touch panel 200 may include a window unit 210, a light source unit 220, detection units 230a and 230b, and reflection units 240a and 240b.

The window unit 210 may be a transparent panel, which may be located above the display panel 100, and thus may transmit an image displayed on the display panel 100. Thereby, a user may see an image of the display panel 100 transmitted through the window unit 210, and may touch the window unit 210 at a position where a desired letter or emoticon is displayed on the display panel, thus obtaining desired data.

The window unit 210 may be configured to reflect external light incident upon the window unit 210 under the condition that an object, for example, a user finger or a pen, does not touch the window unit 210. The window unit 210 may also scatter external light incident upon the window unit 210 at a touch position of the object under the condition that the object, for example, the user finger or the pen, touches the window unit 21. This function of the window unit 210 will be described as follows.

When an incidence angle of external light incident upon the window unit 210 is greater than a critical angle under the condition that the object, for example, the user finger or the pen, does not touch the window unit 210, total reflection in which light is totally reflected by the boundary of the window unit 210 and no reflected ray of light is present is generated. In example embodiments, the critical angle may be an incidence angle when a reflecting angle is about 90 degrees.

In example embodiments, under the condition that the object, for example, the user finger or the pen, touches the window unit 210, the total reflection condition of the external light incident upon the window unit 210 may be changed, and thus light scattering may be generated. For example, the external light incident upon the window unit 210 may collide with the fingerprint of the finger touching the window part 210 or the surface unevenness of the object, and may change a movement direction thereof, thereby the external light may be scattered.

The light source unit 220, which may include a light emitting diode (LED), may be installed at one side of the window unit 210 to output light toward the window unit 210. Thereby, the light source unit 220 may facilitate the total reflection and scattering of light by the window unit 210 according to whether or not the object touches the window unit 210, and may increase the amount of scattered light when the object touches the window unit 210, and thus may increase accuracy in detection of a touch position.

The light source unit 220 may be installed on one side surface of the window unit 210 or at one corner of the window unit 210. That is, by installing the light source unit 220 at one corner of the window unit 210, light outputted from the light source unit 220 may be emitted in the diagonal direction of the window unit 210, and thus may be uniformly emitted to all regions of the window unit 220.

Further, as shown in FIG. 1B, a plurality of the light source units 220 corresponding to the size of the window unit 210 may be installed at regular intervals on one surface of the window unit 210 to increase accuracy in detection of a touch position.

As shown in FIG. 2, first and second detection units 230a and 230b and first and second reflection units 240a and 240b may be respectively installed on the outer circumferential surfaces of the lower portion of the window unit 210. More specifically, the first detection unit 230a and the second detection unit 230b may be respectively installed on two outer circumferential surfaces of the lower portion of the window unit 210, and the first reflection unit 240a and the second reflection unit 240b may be respectively installed on two other outer circumferential surfaces of the lower portion of the window unit 210 to be close to each other. Further, the first detection unit 230a and the first reflection unit 240a may be opposite to each other, and the second detection unit 230b and the second reflection unit 240b may be opposite to each other.

In example embodiments, the first detection unit 230a may capture the image of the first reflection unit 240a, which may be opposite to the first detection unit 230a, and may transmit the obtained image to the control unit 300. In example embodiments, the second detection unit 230b may capture the image of the second reflection unit 240b, which may be opposite to the second detection unit 230b, and may transmit the obtained image to the control unit 300. That is, the first and second detection units 230a and 230b may respectively capture touch images, e.g., images of light reflected by the first and second reflection units 240a and 240b.

In example embodiments, the first and second detection units 230a and 230b may include one of optical systems, which may capture an image, for example, a lens, a complementary metal oxide semiconductor field effect transistor (CMOS), and a charge-coupled device (CCD).

As shown in FIG. 3, the first and second reflection units 240a and 240b may represent two-dimensional coordinates of the window unit 210. The first reflection unit 240a may represent the X-coordinate of the window unit 210, and the second reflection unit 240b may represent the Y-coordinate of the window unit 210.

When an object, for example, a user finger or a pen, touches the window unit 210 and light scattering S is generated at the touch position, the first and second reflection units 240a and 240b may respectively reflect touch images, e.g., images of the scattered light, to the first and second detection units 230a and 230b.

At this time, as shown in FIG. 2, the first and second reflection units 240a and 240b may form a designated angle θ with the side surface of the window unit 210. Therefore, the first and second reflection units 240a and 240b may be tilted relative to the side surface of the window unit 210, and respectively may reflect the touch images on the window unit 210 to the first and second detection units 230a and 230b.

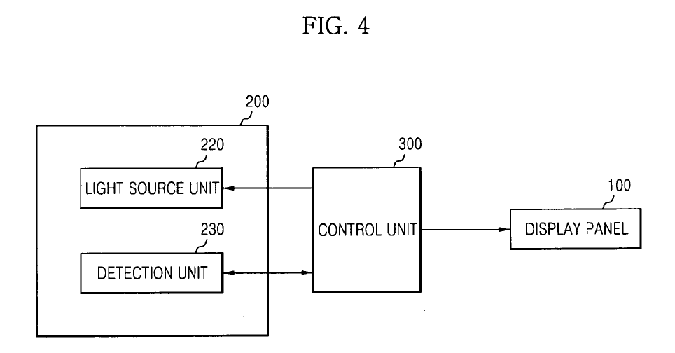

Thereby, the first and second detection units 230a and 230b may capture the images reflected by the first and second reflection units 240a and 240b, and may transmit the obtained images to the control unit 300. This procedure will be described with reference to FIG. 4.

FIG. 4 is a control block diagram of the touch display apparatus in accordance with example embodiments. The touch display apparatus may include the display panel 100, the touch panel 200, and the control unit 300.

The display panel 100 may display an image corresponding to instructions of the control unit 300, and the touch panel 200 may detect, when a touch is inputted by a user, the touch image of the touch position where the touch is inputted, and may. transmit the touch image to the control unit 300.

The control unit 300 may control output of an image from the display panel 100, output of light from the light source unit 220 of the touch panel 200, and driving of the first and second detection units 230a and 230b. Further, the control unit 300 may analyze images transmitted from the first and second detection units 230a and 230b of the touch panel 200 and thus may detect positions of the images reflected by the first and second reflection units 240a and 240b, thereby determining coordinates (1x, 1y) of the touch position. In the control unit 300, two-dimensional X-coordinate and Y-coordinate data corresponding to reflection regions of the first and second reflection units 240a and 240b may be set.

Further, the control unit 300 may display a sub-image corresponding to the touch position among the image displayed on the display panel 100, or may execute a function thereof.

The touch display apparatus may not recognize the overall surface of the window unit 210, but may recognize all coordinates on the window unit 210 using only the detection units corresponding to the two reflection units installed at the lower portion of the window unit 210, when the touch position is determined. Thus, example embodiments may reduce the number of the detection units, which are optical systems, and thus may be economical. Further, because the detection units and the reflection units are located at the lower portion of the window unit, a bezel thickness may be removed and thus the touch panel may be slimmed.

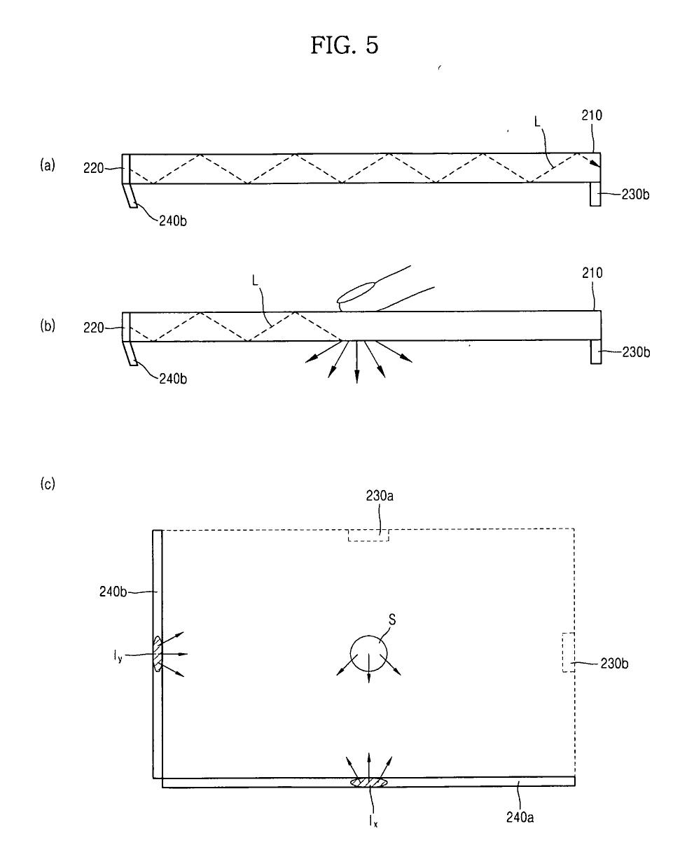

FIGS. 5A to 5C are views illustrating a process of detecting a touch position in the touch display apparatus in accordance with example embodiments. Hereinafter, the driving process and principle of the touch display apparatus will be described with reference to FIGS. 5A to 5C.

As shown in FIG. 5A, the window unit 210 may cause total reflection of light L outputted from the light source unit 220 under the condition that the display panel 100 displays an image.

If a user wishes to perform a desired function, the user may bring an object, for example, a user finger or a pen, into contact with the window unit 210. In other words, the user may touch the window unit 210 with the object. In example embodiments, the user may contact the window unit 210 with the object at a position of the window unit 210 where a letter or emoticon corresponding to the desired function is displayed.

As shown in FIG. 5B, the total reflection condition of the light L at the touch position of the object, such as the user finger or the pen, on the window unit 210 may be changed. Therefore, the light L at the touch position may not be totally reflected, but may be scattered by the fingerprint of the user finger or the surface unevenness of the object, for example, a pen.

As shown in FIG. 5C, the scattered light S may be reflected by the first and second reflection units 240a and 240b, and touch images, e.g., the images of the light reflected by the first and second reflection units 240a and 240b, may be respectively detected by the first and second detection units 230a and 230b.

Coordinates (1x, 1y) of the touch position may be determined by analyzing the positions of the touch images detected by the first and second touch units 230a and 230b, and a sub-image corresponding to the touch position among the image displayed on the display panel 100 may be displayed or a function thereof is executed.

As described above, the touch panel may not recognize the overall surface of the window unit of the touch panel, but may recognize all coordinates on the window unit using only the detection units corresponding to the two reflection unit regions installed at the lower portion of the window unit, when a touch position on the touch panel is determined. Thus the number of the detection units, which are optical systems, may be reduced and the touch panel according to example embodiments may be economical. Further, because the detection units and the reflection units are located at the lower portion of the window unit, a bezel thickness may be removed.

As is apparent from the above description, a touch display apparatus in accordance with example embodiments may remove a bezel around the side surface of a touch panel, and thus may be slimmed.

Further, the touch display apparatus according to example embodiments may have a reduced number of elements, for example, detection units to detect a touch position, and thus may have a simple manufacturing process, a reduced manufacturing cost, and is manufactured in a large size.

Although example embodiments have been shown and described, it would be appreciated by those skilled in the art that changes may be made in example embodiments without departing from the principles and spirit of the invention, the scope of which is defined in the claims and their equivalents.

What is claimed is:

1. A touch panel comprising:
a window unit;
reflection units on the window unit, the reflection units configured to reflect scattered light from the window unit when the window unit is touched; and
detection units on the window unit, the detection units configured to detect the reflected scattered light.

2. The touch panel according to claim 1, wherein the reflection units and the detection units are at a lower portion of the window unit.

3. The touch panel according to claim 1, further comprising:
at least one light source unit configured to output light to the window unit.

4. The touch panel according to claim 3, wherein the at least one light source unit is at one corner of the window unit.

5. The touch panel according to claim 3, wherein the at least one light source unit is a plurality of light source units arranged at regular intervals on one surface of the window unit.

6. The touch panel according to claim 1, wherein the reflection units form a tilt angle with the window unit.

7. The touch panel according to claim 1, further comprising:
a control unit configured to calculate coordinates of a touch position based on positions of the reflected scattered light detected by the detection units.

8. The touch panel according to claim 1, wherein the detection units and the reflection units are opposite to each other.

9. The touch panel according to claim 1, wherein
the reflection units include a first reflection unit and a second reflection unit configured to provide two-dimensional coordinates, and
the detection units include a first detection unit configured to detect light reflected by the first reflection unit, and a second detection unit configured to detect light reflected by the second reflection unit.

10. The touch panel according to claim 1, wherein each of the detection units includes a complementary metal oxide semiconductor field effect transistor (CMOS).

11. The touch panel according to claim 1, wherein each of the detection units includes a charge-coupled device (CCD).

12. A touch display apparatus comprising:
a touch panel including
a window unit,
reflection units on the window unit, the reflection units configured to reflect scattered light from the window unit when the window unit is touched, and
detection units on the window unit, the detection units configured to detect the reflected scattered light; and
a display panel configured to display an image corresponding to a position where the scattered light is detected.

13. The touch display apparatus according to claim 12, wherein the reflection units and the detection units are at a lower portion of the window unit.

14. The touch display apparatus according to claim 12, further comprising:
at least one light source unit configured to output light to the window unit.

15. The touch display apparatus according to claim 12, wherein the reflection units form a tilt angle with the window unit.

16. The touch display apparatus according to claim 12, further comprising:
a control unit configured to calculate coordinates of a touch position based on positions of the reflected scattered light detected by the detection units.

17. The touch display apparatus according to claim 12, wherein the detection units and the reflection units are opposite to each other.

18. The touch display apparatus according to claim 17, wherein
the reflection units include a first reflection unit and a second reflection unit configured to provide two-dimensional coordinates, and
the detection units include a first detection unit configured to detect light reflected by the first reflection unit, and a second detection unit configured to detect light reflected by the second reflection unit.
